(19) United States
(12) Patent Application Publication
(10) Pub. No.: US 2006/0269224 A1
(43) Pub. Date: Nov. 30, 2006

(54) Moving image processing apparatus

(75) Inventor: Takamitsu Hanaoka, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/442,202

(22) Filed: May 30, 2006

(30) Foreign Application Priority Data
May 31, 2005 (JP) 2005-158601

(51) Int. Cl. H04N 5/91

(52) U.S. Cl. 386/94

(57) ABSTRACT

Provided is a moving image processing apparatus that allows, when moving image data recorded on a first recording medium partially includes a copy prohibition, dubbing of the moving image data to a second recording medium in a way sufficiently smart enough to meet a user's expectations. A VOB is sequentially read from a DVD 16 used as the first recording medium as a digital signal starting from the first VOBU #1. The VOBUs #1 to #9 thus read are checked whether or not they are prohibited from being copied in the order in which they are read. The VOBUs #1 to #4 and #7 to #9 that are found not to be prohibited from being copied are converted to an analog signal while skipping the VOBUs #5 and #6 that are found to be prohibited from being copied, and are then played back. The VOBUs #1 to #4 and #7 to #9 thus played back are sequentially converted to a digital signal and then sent therefrom. VOBUs #1′ to #4′ and #7′ to #9′ based on the VOBUs #1 to #4 and #7 to #9 thus sent are sequentially recorded on a hard disk 13 used as the second recording medium.

This application is based on Japanese Patent Application No. 2005-158601 filed on May 31, 2005, the contents of which are hereby incorporated by reference.

### BACKGROUND OF THE INVENTION

1. Field of the Invention

The present invention relates to a moving image processing apparatus that allows dubbing of moving image data recorded on a recording medium such as a hard disk (HD) or a DVD (digital versatile disk) to another recording medium.

2. Description of Related Art

Some recently developed moving image processing apparatuses such as a HDD DVD recorder incorporating an HD drive (hard disk drive (HDD)) and a DVD drive can deal with a plurality of recording media of different types. Such a moving image processing apparatus can perform the following operations: transfer and copying (so-called dubbing) of moving image data from one recording medium to another, that is, dubbing of moving image data recorded on one recording medium (hereinafter may be referred to as a “first recording medium”) to another recording medium (hereinafter may be referred to as a “second recording medium”); reading of moving image data recorded on a recording medium for playing back the data thus read and then making a monitor display the moving image; and receiving of a broadcast program and recording of the program thus received on each recording medium as moving image data.

Incidentally, some moving image data recorded on the first recording medium rightly prohibit the copying of any part thereof from the viewpoint of copyright protection, but others permit, although part thereof is prohibited from being copied, the copying of the other part thereof.

Here, a moving image object (video object (VOB)) constituting moving image data consists of a series of one or more moving image object units (video object units (VOBUs)). Each moving image object unit is the smallest unit of playable data, and is built with a plurality of packs such as a RDI (real-time data information) pack, a V (video) pack, or an A (audio) pack. The RDI pack includes copy information on whether copying of the moving image object unit is permitted or prohibited, that is, information on whether copying of the moving image object unit is prohibited or not.

When the moving image object recorded on the first recording medium partially includes a copy-prohibited moving image object unit, a conventional moving image processing apparatus performs dubbing of the moving image object to the second recording medium in the following manner.

The moving image object units are sequentially read from the first recording medium starting from the first moving image object unit, and the moving image object units thus read are recorded on the second recording medium in the order in which they are read until a copy-prohibited moving image object unit is detected. On the detection of a copy-prohibited moving image object unit, dubbing is stopped, and the following moving image object units are not recorded on the second recording medium. On the other hand, with respect to the moving image object units that have already been recorded on the second recording medium, the following processes are performed: erasing all of them or disabling playback thereof, or tracing copy-prohibited one and erasing it or disabling playback thereof while leaving intact the one whose copying is not prohibited (see JP-A-2004-194139).

As described above, when the moving image object partially includes a copy-prohibited moving image object unit, in particular, when a copy-prohibited moving image object unit is arranged at some midpoint in the moving image object, it may be possible to dub a moving image object unit obtained before a copy prohibition is detected to the second recording medium. However, when a copy-prohibited moving image object unit is arranged at the head of the moving image object, dubbing is not allowed at all.

A disadvantage of this conventional moving image processing apparatus described above is as follows. When the moving image object recorded on the first recording medium partially includes a copy-prohibited moving image object unit and has the part where the copy-prohibited moving image object unit is followed by a copy-permitted moving image object unit, none of the copy-permitted moving image object units following the copy-prohibited moving image object unit, despite being permitted to be copied, are recorded on the second recording medium and thus dubbed thereto.

In other words, depending on how a copy-permitted moving image object unit and a copy-prohibited moving image object unit are arranged, there is a possibility that many of the copy-permitted moving image object units are not dubbed. In that case, the moving image data dubbed to the second recording medium is not sufficient enough to meet a user's expectations.

### SUMMARY OF THE INVENTION

In view of the above problems, it is an object of the present invention to provide a moving image processing apparatus that allows, when moving image data recorded on a first recording medium partially includes a copy-prohibited moving image object unit, dubbing of the moving image data to a second recording medium in a way sufficiently smart enough to meet a user's expectations.

To achieve the above object, according to the present invention, a moving image processing apparatus that dubs a moving image object consisting of a series of a plurality of moving image object units and at least including the part where a copy-prohibited moving image object unit is followed by a copy-permitted moving image object unit from a first recording medium on which the moving image object is recorded to a second recording medium is provided with: a reading portion that sequentially reads, from the first recording medium, the moving image object as a digital signal starting from the first moving image object unit; a checking portion that checks whether or not the moving image object units thus read are prohibited from being copied in the order in which the moving image object units are read; a play back portion that converts, to an analog signal, the moving image object unit that is found not to be prohibited from being copied while skipping the moving image object unit that is found to be prohibited from being copied, and then plays back the analog signal in the order of conversion; a sending portion that converts the moving image object unit thus played back to a digital signal and then sends the digital signal in the order of conversion; and a recording portion that receives the moving image object unit thus sent and records the moving image object unit thus received on the second recording medium in the order of reception.

With this structure, irrespective of how a copy-permitted moving image object unit and a copy-prohibited moving image object unit are arranged, it is possible to dub all the copy-permitted moving image object units from the first recording medium to the second recording medium.

From a practical standpoint, preferably, the moving image object unit thus received is recorded on the second recording medium as a new moving image object in the order of reception.

According to the moving image processing apparatus of the present invention, it is possible to dub all the copy-permitted moving image object units from the first recording medium to the second recording medium. That is, the moving image data dubbed to the second recording medium is all that is permitted to be copied, and thus sufficiently meets a user's expectations.

### BRIEF DESCRIPTION OF THE DRAWINGS

FIG. 1 is a block diagram showing the schematic structure of the HDD DVD recorder as one embodiment of the moving image processing apparatus of the present invention.

FIG. 2 is a diagram schematically showing the structure of moving image data when dubbing is performed by the moving image processing apparatus of FIG. 1.

### DETAILED DESCRIPTION OF PREFERRED EMBODIMENTS

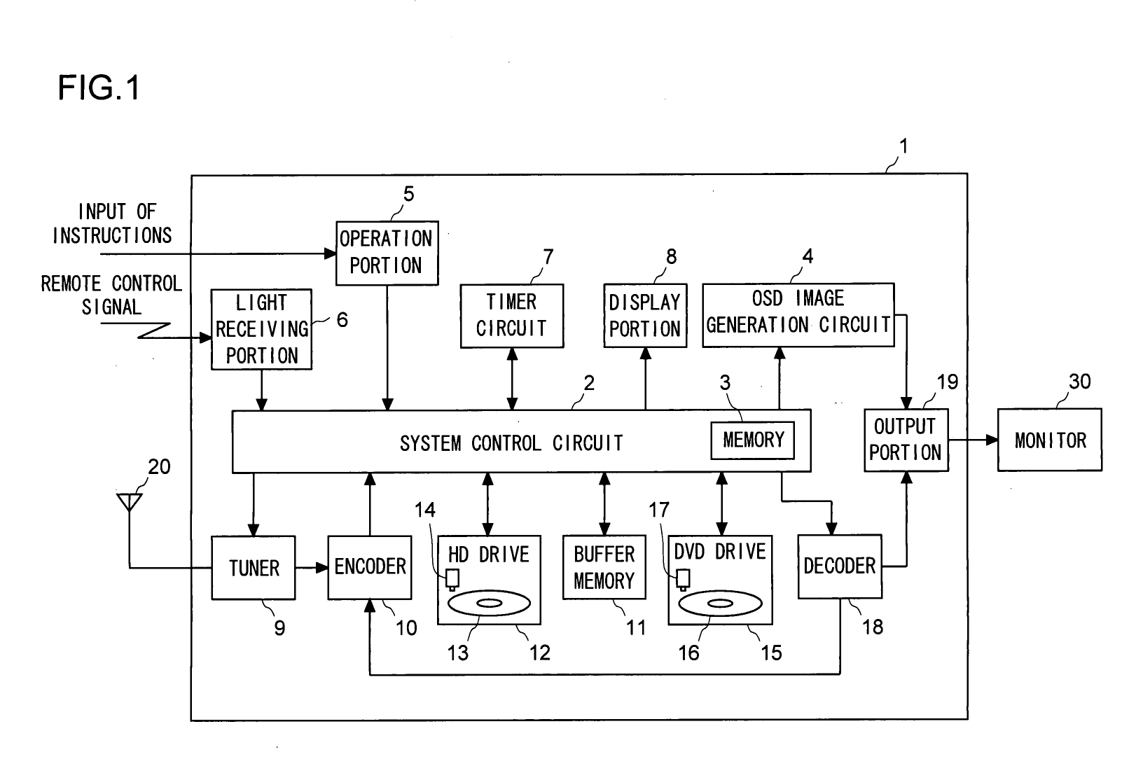

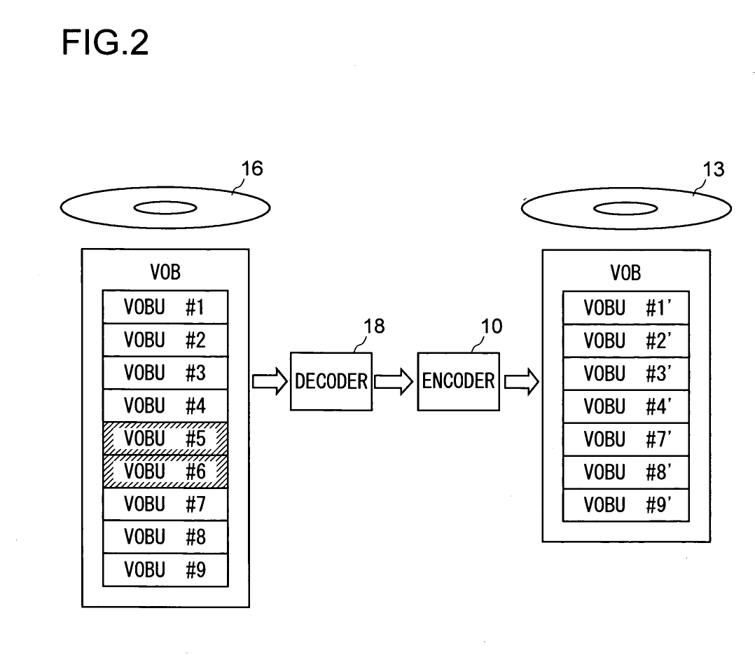

Hereinafter, one embodiment of the moving image processing apparatus of the present invention will be described in detail. FIG. 1 is a block diagram showing the schematic structure of the HDD DVD recorder as one embodiment of the moving image processing apparatus of the present invention. FIG. 2 is a diagram schematically showing the structure of moving image data when dubbing is performed by the HDD DVD recorder.

As shown in FIG. 1, the moving image processing apparatus 1 of the present embodiment is a HDD DVD recorder that adopts a hard disk 13 and a DVD 16 as a recording medium, and can dub moving image data from the hard disk 13 to the DVD 16 and vice versa. Moreover, the moving image processing apparatus can read the moving image data recorded on the hard disk 13 or the DVD 16 therefrom and play back the data thus read, and then make a monitor 30 display the moving image for making the viewing possible. Furthermore, the moving image processing apparatus can receive analog or digital broadcast program and record it on the hard disk 13 or the DVD 16 as moving image data.

The main components of this moving image processing apparatus 1 are a system control circuit 2, an OSD (on screen display) image generation circuit 4, an operation portion 5, a light receiving portion 6, a timer circuit 7, a display portion 8, a tuner 9, an MPEG (Moving Picture Experts Group) encoder 10, a buffer memory 11, a HD drive 12, a DVD drive 15, an MPEG decoder 18, and an output portion 19. The system control circuit 2 includes a memory 3. The HD drive 12 includes the hard disk 13 and an information recording head 14. The DVD drive 15 includes the externally detachable DVD 16 and an information recording head 17. An antenna 20 is connected to the tuner 9. The monitor 30 such as a television or a display-only monitor is connected to the output portion 19.

The system control circuit 2 controls, while performing signal input/output, the entire operations of the moving image processing apparatus 1 such as recording of received moving image data (including audio data), reading of the data thus recorded, and dubbing of data from the hard disk 13 to the DVD 16 and vice versa. The above-described control is performed based on a program previously stored in the memory 3, for example.

On the detection of instructions from the user, the system control circuit 2 generates a signal for making the monitor 30 display a predetermined screen. Such a screen is, for example, a screen for settings of the scheduled recording, a screen on which a moving image based on the recorded data is played back, or a screen for dubbing execution.

The OSD image generation circuit 4 generates a signal for displaying a message image based on the instructions from the operation portion 5 or the instructions obtained from a remote control via the light receiving portion 6, or based on the conditions previously determined in the system control circuit 2. This message image is an image in which, for example, channels, a recording setting screen, a dubbing execution screen, or volume levels are displayed, and is different from a moving image from the HD drive 13. The OSD image generation circuit 4 generates a signal for such a message image, and outputs it to the output portion 19. When this signal is outputted, a message image represented by the signal is displayed on the monitor 30.

The operation portion 5 detects instructions inputted by the user. The operation portion 5 is, for example, an input button provided on a front panel of the moving image processing apparatus 1, but not limited thereto. On the detection of the instructions, a signal for performing a process corresponding to the instructions is generated. This signal is outputted to the system control circuit 2.

The light receiving portion 6 receives a remote control signal transmitted from the remote control. This signal is outputted to the system control circuit 2.

The timer circuit 7 measures time in the moving image processing apparatus 1. Although the timer circuit 7 operates with electric power fed from the outside, it can keep operating for a previously set time even when there is a temporary power failure. The timer circuit 7 outputs time data to the system control circuit 2, and receives a control signal from the system control circuit 2. The time measured by the timer circuit 7 is corrected based on the signal from the system control circuit 2.

The display portion 8 displays information on the moving image processing apparatus 1. This information includes time, receiving channel, counter, recording/playback mode, dubbing mode and other items. The display portion 8 is, for example, an LCD (liquid crystal display) or an LED (light emitting diode) provided on the front panel of the moving image processing apparatus 1, but not limited thereto.

The tuner 9 receives moving image data of an analog or digital broadcast program via the antenna 20. The data signal received by the tuner 9 is outputted to the MPEG encoder 10. Additionally, the tuner 9 can switch receiving channels based on the signal from the system control circuit 2.

The MPEG encoder 10 converts an analog signal received from the tuner 9 to an MPEG encoded digital signal, and then outputs it to the system control circuit 2. Additionally, when dubbing is performed, the MPEG encoder 10 receives from the MPEG decoder 18 a data signal based on the moving image data from the HD drive 12 or the DVD drive 15, converts the data signal to a digital signal, and then outputs it to the system control circuit 2.

Based on the signal from the system control circuit 2, the HD drive 12 writes the MPEG encoded data to the hard disk 13 with the information recording head 14, or reads the data stored in the hard disk 13 therefrom.

Based on the signal from the system control circuit 2, the DVD drive 15 writes the MPEG encoded data to the DVD 16 with the information recording head 17, or reads the data stored in the DVD 16 therefrom.

When a broadcast program is recorded, the buffer memory 11 temporarily stores moving image data received by the moving image processing apparatus 1 based on the signal from the system control circuit 2. The temporarily stored data is then sequentially sent to the HD drive 12 or the DVD drive 15. On the other hand, when dubbing is performed, the buffer memory 11 receives from the MPEG encoder 10 a data signal based on the moving image data from the HD drive 12 or the DVD drive 15, and then temporarily stores it. The temporarily stored data is then sequentially sent to the DVD drive 15 or the HD drive 12, which is a copy destination.

When the recorded moving image is played back, the MPEG decoder 18 decodes the MPEG encoded data read from the HD drive 12 or the DVD drive 15, and then outputs the decoded data to the output portion 19. On the other hand, when dubbing is performed, the MPEG decoder 18 receives the moving image data from the HD drive 12 or the DVD drive 15, converts it to an analog signal, and then outputs it to the MPEG encoder 10.

The output portion 19 outputs the signal from the OSD image generation circuit 4 and the signal from the MPEG decoder 18 to the monitor 30. As a result, a message image generated by the OSD image generation circuit 4 and a moving image read from the HD drive 12 or the DVD drive 15 are displayed on the monitor 30.

Next, the setting of the scheduled recording performed by the moving image processing apparatus 1 will be described. When scheduled recording setting instructions are received from the operation portion 5 or the remote control, the system control circuit 2 makes the OSD image generation circuit 4 display a recording setting screen on the monitor 30. The recording setting screen includes such items as channel of a program to be recorded, recording start time, recording finish time, date of recording, “every week” or “every day” recording, and recording destination (hard disk 13 or DVD 16).

When a series of programs transmitted at a given cycle is recorded according to the cyclic recording, channel of the program, recording start time, recording finish time, and “every week” or “every day” recording corresponding to the cyclic recording, for example, are set mainly by the operation of the remote control. When one-time only scheduled recording is performed, channel of the program, recording start time, recording finish time, and date of recording, for example, are set.

The input setting data on such scheduled recording is stored in the memory 3. The data on the cyclic recording remains stored in the memory 3 until the setting of the cyclic recording is cancelled. On the other hand, the data on the one-time only scheduled recording is cleared when the scheduled recording is completed.

The scheduled recording set as described above is performed as follows. Based on the data on the scheduled recording stored in the memory 3, the system control circuit 2 starts to receive moving image data of a predetermined channel at a predetermined start time from the tuner 9 via the MPEG encoder 10. The moving image data thus received is temporarily stored in the buffer memory 11, and is then sequentially sent to a drive for a predetermined recording medium (the HD drive 12 or the DVD drive 15). The data thus sent is written to the hard disk 13 or the DVD 16 with the information recording head 14 or 17, and is recorded thereon. Then, at a predetermined finish time, these operations are ended, and the recording is completed.

Next, how dubbing is performed by the moving image processing apparatus 1 will be described also with reference to FIG. 2. When dubbing execution instructions are received from the operation portion 5 or the remote control, the system control circuit 2 makes the OSD image generation circuit 4 display a dubbing execution screen on the monitor 30. On the dubbing execution screen, a source recording medium and a destination recording medium and a moving image to be dubbed, for example, are set by the operation of the operation portion 5 or the remote control, and then execution start is inputted.

The following description assumes that the DVD 16 is set as a source recording medium (a first recording medium) and the hard disk 13 is set as a destination recording medium (a second recording medium), and deals with a case where the moving image data that is recorded on the DVD 16 and is desired to be dubbed partially includes a copy prohibition.

For example, as shown in FIG. 2, the moving image data, namely, the moving image object (VOB) that is recorded on the DVD 16 used as a first recording medium and is desired to be dubbed consists of a series of nine moving image object units (VOBUs) #1 to #9. Of these VOBUs #1 to #9, the fifth VOBU #5 and the sixth VOBU #6 are prohibited from being copied (see the hatched portion in FIG. 2), and the others, that is, the first VOBU #1 to the fourth VOBU #4 and the seventh VOBU #7 to the ninth VOBU #9 are not prohibited from being copied. In other words, there is the part where the copy-prohibited moving image object units (VOBUs #5 and #6) are followed by the copy-permitted moving image object units (VOBUs #7 to #9).

When a dubbing start input is received by the system control circuit 2, the VOBUs are sequentially read from the DVD 16 by the DVD drive 15 as a digital signal starting from the first VOBU #1. The moving image object units thus read are checked whether or not they are prohibited from being copied in the order they are read based on the copy information provided one for each of the moving image object units.

The moving image object units (VOBUs #1 to #4 and #7 to #9) that are found not to be prohibited from being copied are sequentially sent to the MPEG decoder 18. On the other hand, the moving image object units (VOBUs #5 and #6) that are found to be prohibited from being copied are not sent to the MPEG decoder 18.

In the MPEG decoder 18, the VOBUs #1 to #4 and #7 to #9 thus received are sequentially converted to an analog signal, and data on the analog signal based on the VOBUs #1 to #4 and #7 to #9 is sequentially sent to the MPEG encoder 10.

In the MPEG encoder 10, the received data on the analog signal based on the VOBUs #1 to #4 and #7 to #9 is sequentially converted to a digital signal, and the digital signal data thus obtained is sequentially sent to the buffer memory 11 and is then temporarily stored therein.

From the buffer memory 11, the temporarily stored data VOBUs #1′ to #4′ and #7′ to #9′ on the digital signal based on the VOBUs #1 to #4 and #7 to #9 is sequentially sent to the HD drive 12 provided with the hard disk 13 used as the second recording medium. In the HD drive 12, the VOBUs #1′ to #4′ and #7′ to #9′ thus received are written to the hard disk 13 with the information recording head 14 in the order in which they are received.

Here, the VOBUs #1′ to #4′ and #7′ to #9′ based on the moving image object units (the VOBUs #1 to #4 and #7 to #9) that are found not to be prohibited from being copied are collectively recorded on the hard disk 13 as a new moving image object (VOB). This is because, since the moving image object unit read from the DVD 16 is, instead of being directly recorded on the hard disk 13, temporarily converted to an analog signal, which is a signal for play back, and is then converted to a digital signal again, it is not subject to constraints imposed by the standard with which it complies at the time of being recorded on the hard disk 13.

In this way, dubbing from the DVD 16 used as the first recording medium to the hard disk 13 used as the second recording medium is completed.

It is to be noted that, when the moving image data that is recorded on the DVD 16 and is desired to be dubbed includes a copy-prohibited moving image object unit at the head thereof, data based on the following copy-permitted moving image object units is sequentially recorded on the hard disk 13 as a new moving image object.

When dubbing is performed by the moving image processing apparatus 1 in a manner as described above, even when the moving image data recorded on the DVD 16 used as the first recording medium partially includes a copy-prohibited moving image object unit, irrespective of how a copy-permitted moving image object unit and a copy-prohibited moving image object unit are arranged, it is possible to dub all the copy-permitted moving image object units from the DVD 16 to the hard disk 13 used as the second recording medium. As described above, the moving image data dubbed to the second recording medium is all that is permitted to be copied, and thus sufficiently meets a user's expectations.

It is to be understood that the present invention is not limited in any way by the embodiment thereof described above, because the above embodiment is merely an example of how the invention can be implemented. The embodiment described above deals with a case where a DVD is selected as a first recording medium, which is a copy source, and a hard disk is selected as a second recording medium, which is a copy destination. In practice, however, it is possible to select a hard disk as a first recording medium and select a DVD as a second recording medium. In that case, an example of the moving image data recorded on a hard disk and partially including a copy prohibition is moving image data that allows copying only once and is dubbed to the hard disk from a DVD.

As the first and second recording media, it is possible to use, for example, a memory card that allows data to be erased therefrom/written thereto at will and can retain the contents thereof after powering off. Incidentally, as a second recording medium, it is possible to use a video tape.

Obviously, many modifications and variations of the present invention are possible in light of the above teachings. It is therefore to be understood that within the scope of the appended claims, the invention may be practiced other than as specifically described.

What is claimed is:

1. A moving image processing apparatus that dubs a moving image object consisting of a series of a plurality of moving image object units and at least including part where a copy-prohibited moving image object unit is followed by a copy-permitted moving image object unit from a first recording medium on which the moving image object is recorded to a second recording medium, the moving image processing apparatus comprising:
a reading portion that sequentially reads, from the first recording medium, the moving image object as a digital signal starting from a first moving image object unit;
a checking portion that checks whether or not the moving image object units thus read are prohibited from being copied in an order in which the moving image object units are read;
a play back portion that converts, to an analog signal, the moving image object unit that is found not to be prohibited from being copied while skipping the moving image object unit that is found to be prohibited from being copied, and then plays back the analog signal in an order of conversion;
a sending portion that converts the moving image object unit thus played back to a digital signal and then sends the digital signal in an order of conversion; and
a recording portion that receives the moving image object unit thus sent and records the moving image object unit thus received on the second recording medium in an order of reception.

2. The moving image processing apparatus of claim 1,
wherein the moving image object unit thus received is recorded on the second recording medium as a new moving image object in an order of reception.

3. The moving image processing apparatus of claim 1,
wherein the first recording medium is a DVD and the second recording medium is a hard disk.
